(19) United States
(12) Patent Application Publication
(10) Pub. No.: US 2024/0288085 A1
(43) Pub. Date: Aug. 29, 2024

(54) DEVICE FOR CONTROLLING THE FLOW OF A CRYOGENIC MEDIUM

(71) Applicants: Messer SE & Co. KGaA, Bad Soden (DE); Messer France S.A.S., Suresnes Cedex (FR)

(72) Inventors: Emir Tebib, Gressy (FR); Denis Beil, Niederkassel (DE); Frank Gockel, Velbert (DE)

(73) Assignees: Messer SE & Co. KGaA, Bad Soden (DE); Messer France S.A.S., Suresnes Cedex (FR)

(21) Appl. No.: 18/571,468

(22) PCT Filed: Jun. 24, 2022
(86) PCT No.: PCT/EP2022/067457

§ 371 Date: Dec. 18, 2023

(30) Foreign Application Priority Data
Jun. 25, 2021 (DE) 10 2021 003 302.7

(51) Int. Cl. F16K 27/02; F16K 15/02; F16K 15/06

(52) U.S. Cl. CPC F16K 27/0209; F16K 15/026; F16K 15/065

(57) ABSTRACT

A process for cooling products is known in which a cryogenic medium, for example liquid nitrogen, liquid oxygen, or liquid carbon dioxide, is metered directly into a container which contains the product. In the event of damage to a fitting which conducts the cryogenic medium, parts of the material of the fitting can reach the product. While this can be quickly ascertained by metal detectors when using metal materials, a comparable verification can only be carried out with difficulty when using plastic parts. According to the invention, plastic elements contained in the device, such as seals for example, are made of a plastic which is mixed with metal additives. In the event of damage, particles originating from the plastic elements can thus also be reliably detected by metal detectors.

### CROSS-REFERENCE TO RELATED APPLICATIONS

The present application is the U.S. national stage application of international application PCT/EP2022/067457 filed Jun. 24, 2022, which international application was published on Dec. 29, 2022, as International Publication WO 2022/269088 A1. The international application claims priority to German Patent Application No. 10 2021 003 302.7 filed Jun. 25, 2021. The international application and German application are hereby incorporated herein by reference.

### FIELD

The invention relates to a device for controlling the flow of a cryogenic medium, having a fitting which is constructed from a plurality of interacting functional elements, wherein at least one of the functional elements is designed as a plastic element.

### BACKGROUND

In many industrial applications, particularly in the field of food technology, cryogenic media, such as cryogenically liquefied gases, are used to cool or freeze liquid, pasty or solid products. Heat is transferred here either indirectly on heat exchanger surfaces, i.e. without material contact between the product to be cooled and the cryogenic medium, or by direct cooling of the product with the cryogenic medium. In the case of direct cooling, the product to be cooled is typically fed through a pipe or is collected in a container and the cryogenic medium is introduced into the pipe or into the container via suitable nozzles or valves. In the following, the terms “pipe” and “container” are subsumed under the term “container”.

EC Directive No. 1935/2004 regulates the placing on the market of materials and articles intended to come into contact directly or indirectly with foodstuffs. In particular, this directive regulates the requirement for traceability of the materials, which must be guaranteed at all stages. Articles that are intended for conveying or controlling the substance flows of cryogenic media now often have components made of different materials. This makes them considerably more difficult to use in the food sector, as the legally required traceability can only be guaranteed with correspondingly complex detection equipment that reflects the diversity of the materials.

For example, devices for metering a cryogenic medium into a container are known from EP 1 867 902 A2 and EP 2 309 160 A1. These devices are used in particular to cool a food product in a container, for example a mixer, by feeding in the cryogenic medium, wherein the latter is preferably fed to a lower region of the container, i.e. in that region of the container that is filled with the product to be cooled during treatment. In this procedure, also referred to as “bottom injection” in technical jargon, care must be taken to ensure that the valve can be closed to prevent product from entering the interior of the device in such phases during treatment when no cryogenic medium is being introduced. In the devices known from EP 1 867 902 A2 and EP 2 309 160 A1, this is achieved in that the devices have a closure body which is arranged in a guide channel of the housing so that it can move axially to a limited extent against the action of a spring and is equipped with a closing disk. The spring has the effect that the feed of the cryogenic medium is only made possible above a predetermined excess pressure on the inflow side; if the pressure falls below this value, the closing disk, by contrast, is pressed against a valve seat on the housing so that it is leak-tight. However, this design means that the devices are composed of several parts, between each of which a sealant ensures the required leak tightness. In the subject matter of EP 1 867 902 A2 and EP 2 309 160 A1, these sealants, and in other comparable fittings from the prior art, are often made of a flexible, low-temperature-resistant plastic, such as PTFE, whereas the other parts of the fitting are generally made of metal. When these items are used in the food sector, this leads to increased complexity with respect to the fulfilment of the legal burden of proof for the reason mentioned above.

### SUMMARY

The object of the present invention is therefore to improve a device for controlling the flow of a cryogenic medium in such a way as to facilitate the verification of and compliance with the legal requirements for traceability.

This object is achieved by a device of the type and purpose mentioned at the outset in that at least one plastic element is formed from a plastic mixed with metallic additives.

The device according to the invention thus has a functional element or several functional elements which is/are made of plastic (referred to here as “plastic element” or “plastic elements”), at least one of which is/are formed from a plastic mixed with metallic additives.

The metallic additives allow plastic material originating from the device, in particular plastic elements such as seals, to be visualized using metal-sensitive detectors, as are already commonly used now in food production. In the case that plastic particles enter the production process in the event of damage, they are recognized while production is still running and the damaged fitting can then be removed from circulation. This is a simple way of meeting the requirements of EU Directive 1935-2004 in particular with respect to the plastic parts in the device.

The metallic additives are either mixed into the crude mass of the plastic during production of the plastic elements or are applied as a coating to the appropriate element. The metallic additives are preferably small metal particles, especially metallic nanoparticles, which are present in a size range between 10 nm and 1000 nm as a colloidal disperse phase in the plastic acting as dispersion medium. The elastic and low-temperature-resistant properties of the plastic are not, or only slightly, impaired by such nanoparticles, and at the same time they are readily detectable by conventional metal detectors used in food production.

The plastic of the plastic elements mixed with the metallic additives are in particular PTFE, nylon or polyethylene, with particular preference being given to PTFE due to its particularly good low-temperature properties.

Preferably, the fitting is a valve that can be connected to a feed line for the cryogenic medium for metering the cryogenic medium into a container, which is constructed of several metallic parts that are detachably connected to one another, with plastic elements being arranged between at least some parts which are made of a plastic mixed with metallic additives. The plastic elements are in particular sealants, for example sealing rings, composed of a flexible, but low-temperature-resistant plastic, such as PTFE. The valve is used in particular to introduce precisely measured amounts of cryogenic medium directly into a product situated in the container in order to cool said product, and the sealants are used in particular to prevent the cryogenic medium from escaping from the valve and/or to prevent the product or surrounding atmosphere from penetrating into the valve.

In a particularly preferred configuration, the valve is a device of the type as described in EP 1 867 902 A2 or EP 2 309 160 A1, to which explicit reference is made here. Such a device has a valve housing constructed at least of a front housing part and a rear housing part, between which a sealant in the form of a sealing ring is arranged. A shut-off element is arranged in the valve housing, which is equipped with a disk-shaped front section on the end face. The shut-off element is accommodated in the valve housing with limited movement against the action of a spring, wherein the movement in the direction of opening is preferably towards the interior of the container. The restoring force of the spring determines a differential pressure above which the valve opens. For example, the differential pressure when using liquid nitrogen as cryogenic medium is 2 to 2.5 bar, and 7 to 9 bar when using liquid carbon dioxide. In the closed state, the disk-shaped front section rests on a valve seat of the valve housing, wherein a sealant made of a flexible and low-temperature-resistant material in the form of a sealing ring ensures a leak-tight contact. The sealant is preferably attached here to the disk-shaped front section of the shut-off element (on its side facing the valve seat) or inserted in the valve seat, for example in a groove running all the way round; however, sealants can also be provided both in the front section and in the valve seat. In accordance with the invention, the sealant between the two housing parts and/or the sealant between the disk-shaped front section and the valve seat consists here of a plastic mixed with metallic additives.

The vessel is, for example, a pipe or a container, in particular a container of a mixer or cutter. The valve can be arranged here in such a way that it opens into a lower region of a container that is filled with product when the device is used. In such a configuration, also known as “bottom injection”, the cryogenic medium comes into contact directly with the product to be cooled, which means that particular attention must be paid to the traceability of undesirable materials that may be introduced into the food product via the cryogenic medium.

The cryogenic medium preferably used is cryogenically liquified nitrogen or liquid carbon dioxide.

### BRIEF DESCRIPTION OF THE DRAWING

A working example of the invention will be elucidated in more detail with reference to the FIGURE. The single FIGURE schematically shows a device according to the invention for metering a cryogenic medium into a container.

### DETAILED DESCRIPTION

The device shown in the FIGURE is used to introduce a cryogenic medium, for example a liquefied gas such as liquid nitrogen, liquid oxygen or liquid carbon dioxide or also a cold gas, for example cryogenic gaseous nitrogen, into a substance to be cooled, which may be for instance a gas, a liquid or a pasty, pulverulent or lumpy substance.

The device comprises a valve 1, which in the working example is mounted on a container 2 in which the substance to be cooled is stored or processed. The valve 1 has a valve body consisting of two housing parts 6, 7. The front housing part 6 is detachably fastened in a container wall 3 of the container 2, for example screwed into a thread 5, specifically in such a way that the front of the housing part 6 terminates essentially flush with an inner surface 9 of the container wall 3. The rear housing part 7 of the valve body is also detachably fastened to the front housing part 6, for example by means of a thread 8, wherein the end face of the front housing part 6 facing the rear housing part 7 protrudes with an annular shoulder 10 inside the rear housing part 7. At its end opposite the front housing part 6, the rear housing part 7 has a connector 4 for connection to a feed line (not shown here) for a cryogenic medium. The connector 4 is adapted here to the type of feed line for the cryogenic medium and is designed in some cases to be resistant to pressure and/or low temperatures. For example, the connector 4 is a threaded connection or a flange.

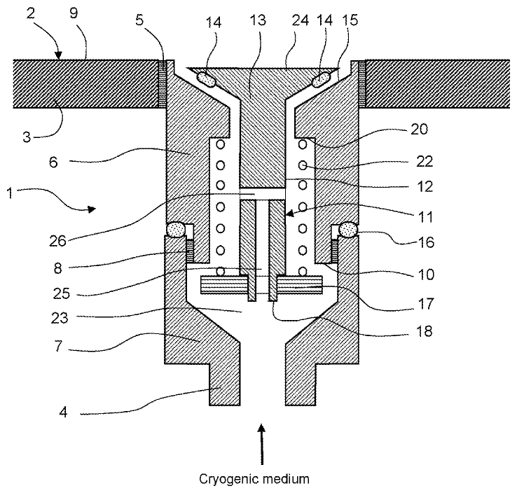

A shut-off element 11, by means of which the valve 1 can be closed and opened, is axially movably accommodated inside the housing parts 6, 7, which are each constructed in essentially rotationally symmetrical fashion. The shut-off element 11 comprises an essentially cylindrical inner section 12, the end face of which facing the container 2 is matched by a disk-shaped front section 13 having a conical cross section, the shape of which is adapted to a conically shaped valve seat 15 in the front housing part 6. On the side of the front section 13 of the shut-off element 11 facing the valve seat 15, a sealing ring 14 is arranged in an all-round groove, which sits on the valve seat 15 when the valve 1 is in the closed state. In the open state, however, the front section 13 with the sealing ring 14—as shown in FIG. 1—protrudes at a distance from the valve seat 15.

A further sealing ring 16 made of a flexible, low-temperature-resistant material is arranged between the front housing part 6 and the rear housing part 7 in corresponding grooves running all around in the housing parts 6, 7. The sealing ring 16 is intended in particular to prevent cryogenic medium from escaping in the region of the connection between the front housing part 6 and the rear housing part 7 during operation of the device.

On the side of the inner section 12 of the shut-off element 11 facing away from the container 2, an annular rear section 17 is provided, which is detachably mounted, for example screwed, on a retaining section 18 of the inner section 12. The outer radius of the rear section 17 is larger than the internal diameter of the annular shoulder 10 of the valve body. When the valve 2 is opened, the annular shoulder 10 therefore limits the axial displaceability of the shut-off element 11 towards the inside of the container 2; in the maximum open state, the rear section 17 rests on the annular shoulder 10. In the closed state of the valve 2, on the other hand, the rear section 17 is arranged at a distance from the annular shoulder 10. To ensure a flow connection inside the valve body on both sides of the rear section 17, even when the rear section 17 is in contact with the annular shoulder 10, the inner section 12 of the shut-off element 11 is provided with a central bore 25, which opens approximately in the center of the inner section 12 into a radial bore 26, which in turn ends radially on the outside of the inner section 12 of the shut-off element 11.

A spiral-shaped closing spring 22 extends all around the inner section 12 of the shut-off element 11 between the rear section 17 and a spring seat 20 on the front housing part 6 of the valve body. The closing spring 22 is clamped between the spring seat 20 and the rear section 17 of the shut-off element 11 in such a way that it is already under a certain pretension in the closed position of the valve 2. As a result, the valve 1 only opens when there is a certain differential value (limit pressure) between the pressure inside the valve body and the pressure in the container interior of for example 2 to 9 bar, which is determined by the spring force of the closing spring 20. If the limit pressure is exceeded, the shut-off element 11 is displaced axially in the direction of the container interior due to the excess pressure acting on the disk-shaped front section 13 of the shut-off element 11 inside the valve body against the action of the closing spring 22. This causes an annular gap to open between the front section 13 of the shut-off element 11 and the valve seat 15 and thus opens up a flow path into the interior of the container 2.

The conical shape of the front section 13 of the shut-off element 11 causes the cryogenic medium to be deflected in a radial direction as it flows into the container 2 and to be distributed very widely in the container 2. The maximum advance of the shut-off element 11, which is set by the distance between the rear section 17 and the annular shoulder 10 in the closed state of the valve, is selected here so that the end face 24 of the front section 13 does not protrude further into the interior of the container 2 until it is essentially arranged flush with the inner surface 9 of the container wall 3. An agitator or slide valve arranged in the container 2, which extends as far as the container walls, is therefore not obstructed by the valve 1.

If the pressure in the interior space 23 of the valve body falls below the limit pressure defined above, the valve 1 closes automatically by the shut-off element 11 moving into its blocking position under the action of the closing spring 22, in which the disk-shaped front section 13 with the sealing element 14 rests on the valve seat 15. No external actuation of the shut-off element 11 is required for this; the amount of cryogenic medium introduced into the container 2 is metered directly by changing the pressure in the feed line or in the interior space 23 of the valve 1. Since the limit pressure is greater than the internal pressure in the container 2 due to the pretension of the closing spring 22, no product can penetrate from the container 2 into the interior space 23 of the valve 1. This also applies in particular in the event of a sudden, unforeseen drop in pressure in the supply line of the cryogenic medium. The device according to the invention is therefore also suitable for “bottom injection”, i.e. for installing the valve 1 in a region of the container wall 3 that is wetted by the product to be cooled during use. However, the valve 1 can of course also be arranged in the head space of the container 2 or in a pipe conveying the product.

The housing parts 6, 7 of the valve body, shut-off element 11 and spring 22 are made of a material that takes into account the low temperatures and/or the high pressures of the cryogenic medium used in each case, for example made of a suitable, low-temperature-resistant stainless steel. In the event of damage, where valve material can enter the product in the container via the cryogenic medium, the process sequence can be monitored using conventional metal detectors, for example an X-ray detector, in order to be able to recognize metal particles originating from the valve in the event of damage.

In order to enable detection of particles originating from the sealing rings 14, 16, these are produced from a plastic mixed with metallic additives. This means that material originating from the sealing rings 14, 16 can also be detected with conventional metal detectors. The plastic is PTFE, for example, and the metallic additives are metallic micro- or nanoparticles, for example, which were mixed into the liquid plastic mass during the manufacture of the sealing rings 14, 16.

Since particles of all components of the valve 1 that enter the product in the event of damage can thus be easily recognized, the device according to the invention satisfies in particular the high hygienic requirements in the production or processing of foodstuffs, for example for cooling dough, flour, mash or meat mass for sausage production or when dosing a cryogenic medium into a line through which a gas or a liquid flows, for example when treating wine, juices or milk for cooling or sterilization purposes, and in the production or processing of pharmaceutical products, preliminary products and ingredients or biological samples.

### REFERENCE SYMBOL LIST

1. Valve
2. Container
3. Container wall
4. Connector
5. Thread
6. Front housing part of the valve body
7. Rear part of the valve body
8. Thread
9. Inner surface (of the container wall)
10. Annular shoulder
11. Shut-off element
12. Inner section
13. Front section
14. Sealing ring
15. Valve seat
16. Sealing ring
17. Rear section
18. Retaining section
19. -
20. Spring seat
21. -
22. Closing spring
23. Interior space of the valve body
24. End face
25. Central bore
26. Radial bore

1. A device for controlling the flow of a cryogenic medium, the device having:
a fitting which is constructed from a plurality of interacting functional elements;
wherein at least one of the functional elements is designed as a plastic element; and
wherein at least one plastic element is made from a plastic mixed with metallic additives.

2. The device as claimed in claim 1, wherein PTFE, nylon or polyethylene is used as plastic in the at least one plastic element mixed with metallic additives.

3. The device as claimed in claim 1, wherein the metallic additives used in the plastic element are metallic nanoparticles.

4. The device as claimed in claim 1, wherein a valve connectable to a supply line for the cryogenic medium is provided as a fitting for metered addition of the cryogenic medium into a container, which valve is constructed from a plurality of metallic parts detachably connected to one another, wherein at least one plastic element is arranged between the parts and is made from a plastic mixed with metallic additives.

5. The device as claimed in claim 4, wherein the valve comprises a valve housing and a shut-off element equipped with a disk-shaped front section;
wherein the valve housing is constructed from a front housing part and a rear housing part, between which a sealant is arranged, and the shut-off element can be moved to an open state against the action of a spring, but in a closed state of the valve, rests on a sealant with the disk-shaped front section, which is arranged in a valve seat of the valve housing or in the front section on its side facing the valve seat; and
wherein at least one sealant is made from a plastic mixed with metallic additives.

6. The device as claimed in claim 4, wherein the container is integrated in a mixing device for a product, particularly for a food product.

7. The device as claimed in claim 1, wherein liquid nitrogen or liquid carbon dioxide is used as the cryogenic medium.
